(19) United States
(12) Patent Application Publication
(10) Pub. No.: US 2007/0087257 A1
(43) Pub. Date: Apr. 19, 2007

(54) Bipolar plate and fuel cell stack using the same

(76) Inventors: In Hyuk Son, Yongin (KR); Han Kyu Lee, Yongin (KR); Chan Kwak, Yongin (KR); Ho Jin Kweon, Yongin (KR)

Correspondence Address: CHRISTIE, PARKER & HALE, LLP, PO BOX 7068, PASADENA, CA, 91109-7068, US

(21) Appl. No.: 11/582,622

(22) Filed: Oct. 17, 2006

(30) Foreign Application Priority Data
Oct. 19, 2005 (KR) 2005-98649

(51) Int. Cl. H01M 8/02; H01M 8/10

(52) U.S. Cl. 429/38; 429/30

(57) ABSTRACT

A bipolar plate and a fuel cell stack using the same. The bipolar plate used in the fuel cell stack includes: a first plate having a fuel flow passage; and a second plate having an oxidant flow passage and a land, the land being on the second plate and formed to be partially opposite to the fuel flow passage. Further, the fuel cell stack includes: a polymer electrolyte membrane; an anode electrode and a cathode electrode respectively placed on opposite sides of the polymer electrolyte membrane; a first plate placed on the anode electrode, and having a fuel flow passage; and a second plate placed on the cathode electrode, and having an oxidant flow passage and a land, the land being on the second plate and formed to be partially opposite to the fuel flow passage.

### CROSS-REFERENCE TO RELATED APPLICATION

This application claims priority to and the benefit of Korean Patent Application No. 10-2005-0098649, filed on Oct. 19, 2005, in the Korean Intellectual Property Office, the entire content of which is incorporated herein by reference.

### BACKGROUND

1. Field of the Invention

The present invention relates to a direct methanol fuel cell system, and more particularly, to a bipolar plate and a fuel cell stack using the same, which can improve output performance of a fuel cell.

2. Discussion of Related Art

A fuel cell is a power generation system that generates electric energy due to electrochemical reaction between hydrogen and oxygen. Fuel cells can be categorized into phosphate fuel cells, molten carbonate fuel cells, solid oxide fuel cells, polymer electrolyte membrane fuel cells, and alkaline fuel cells depending on the kinds of electrolyte used. Each fuel cell operates on about the same principle, but they vary in the kind of fuel, operation temperature, catalyst, and electrolyte used.

A polymer electrolyte membrane fuel cell (PEMFC) has an output performance that is higher than other types of fuel cells. In addition, the PEMFC has a low operating temperature and a quick start and response speed. As such, the PEMFC is widely used as a transportable power source for a portable electronic apparatus or a vehicle, as well as a distributed power source such as a stationary power plant for a house or a public structure.

A direct methanol fuel cell (DMFC) is similar to the PEMFC, but the DMFC can directly supply liquid methanol fuel to its stack. Since the DMFC does not need to use a reformer that is in the PEMFC, it can be small in size.

A fuel cell stack includes a plurality of fuel cell units stacked adjacent to one another. Each of the fuel cell units includes a membrane electrode assembly (MEA), and a separator (or a bipolar plate) formed with channels to supply fuel and oxidant to respective electrodes of the MEA.

FIG. 1 is an exploded sectional view showing a conventional fuel cell unit with separators.

Referring to FIG. 1, the conventional fuel cell unit includes a membrane electrode assembly (MEA) 10 having an electrolyte 12, and anode and cathode electrodes 14 and 16 respectively attached to the opposite sides of the electrolyte 12; an anode plate 20 formed with a fuel flow passage 22; and a cathode plate 30 formed with an oxidant flow passage 32. Typically, the anode plate 20 is directly attached with an adjacent cathode plate of another MEA, and the cathode plate 30 is directly attached with an adjacent anode plate of another MEA, thereby forming two separate bipolar plates. Each of the anode electrode 14 and the cathode electrode 16 includes a catalyst layer 14a, 16a and a diffusing layer 14b, 16b for electrochemical reaction, ion conduction, electron conduction, fuel transfer, byproduct transfer, and interfacial stability.

A bipolar plate may be used not only as a device having a passage through which fuel and oxygen needed for the reaction of the fuel cell flow but may also be used as a conductor for electrically connecting an anode electrode of a first MEA and a cathode electrode of a second MEA. The first and second MEAs are respectively stacked to opposite sides of the MEA 10 in series. The bipolar plate may be made by using a graphite or metal block having a thickness (which may be predetermined) to have certain conductive and airtight properties. As such, It is complicated to design a bipolar plate that can properly supply fuel and oxidant to all fuel cell units of a stack through its flow passages (e.g., the flow channels 22 and 32).

In addition, a number of fuel cell units are needed to be stacked adjacent to one another to manufacture a fuel cell stack having a desired output performance. However, as the number of the fuel cell units that are stacked increases, the volume of the fuel cell stack also increases. On the other hand, as the number of the fuel cell units that are stacked decreases, the volume of the fuel cell stack decreases, but the output performance of the fuel cell stack is lowered as the number of fuel cells decreases. As such, it is difficult to get a desired performance using a fuel cell stack having a small size.

### SUMMARY OF THE INVENTION

Accordingly, embodiments of the present invention provide a bipolar plate and a fuel cell stack using the same, which can improve output performance without increasing the volume of the fuel cell stack.

One embodiment of a bipolar plate according to the invention includes a first plate having a fuel flow passage and a second plate having an oxidant flow passage and a land, the land being on the second plate and formed to be partially opposite to the fuel flow passage.

Another embodiment of a fuel cell stack according to the invention includes: a polymer electrolyte membrane; an anode electrode and a cathode electrode respectively placed on opposite sides of the polymer electrolyte membrane; a first plate placed on the anode electrode, and having a fuel flow passage; and a second plate placed on the cathode electrode, and having an oxidant flow passage and a land, the land being on the second plate and formed to be partially opposite to the fuel flow passage.

In one embodiment, the oxidant flow passage has a meandering shape. The land on the second plate has a first width, and a land on the first plate formed to be substantially opposite to the oxidant flow passage has a second width, and the first width is two times larger than the second width.

In one embodiment, at least one of the fuel flow passage or the oxidant flow passage includes a plurality of channels to guide the fuel or the oxidant.

In one embodiment, the oxidant flow passage has a meandering shape. The land on the second plate has a first width, the channels have a second width, and a rib between the channels has a third width, and the first width is equal to the second width plus twice the third width.

In one embodiment, the fuel flow passage has a first meandering shape, the oxidant flow passage has a second meandering shape, and the fuel flow passage and the oxidant flow passage are substantially crossed with each other.

In one embodiment, a width of the land defined by the oxidant flow passage is larger than a width of one of the channels of the fuel flow passage.

In one embodiment, the first plate and the second plate are adhered to expose the fuel flow passage and the oxidant flow passage to opposite sides thereof.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an exploded sectional view showing a conventional fuel cell unit with separators;

FIG. 2 is a plan view of a bipolar plate according to one embodiment of the present invention;

FIG. 3 is a plan view of a bipolar plate according to another embodiment of the present invention;

FIG. 4 is an exploded perspective view of a fuel cell stack using the bipolar plate of FIG. 3;

FIG. 5 is a plan view of a bipolar plate according to yet another embodiment of the present invention;

FIG. 6 is a sectional view of a fuel cell stack using the bipolar plate of FIG. 5; and

FIG. 7 is a graph showing the output performance of the fuel cell stack according to an embodiment of the present invention.

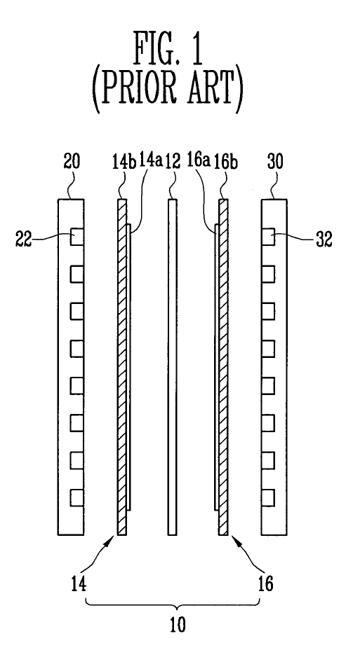

### DETAILED DESCRIPTION

In the following detailed description, certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive.

Hereinafter, a bipolar plate may refer to a plate including a mono-polar plate formed with a fuel flow passage or an oxidant flow passage in which at least one side of the plate faces an MEA. In addition, a bipolar plate may refer to a plate including two mono-polar plates coupled to form a single body (i.e., to form the bipolar plate).

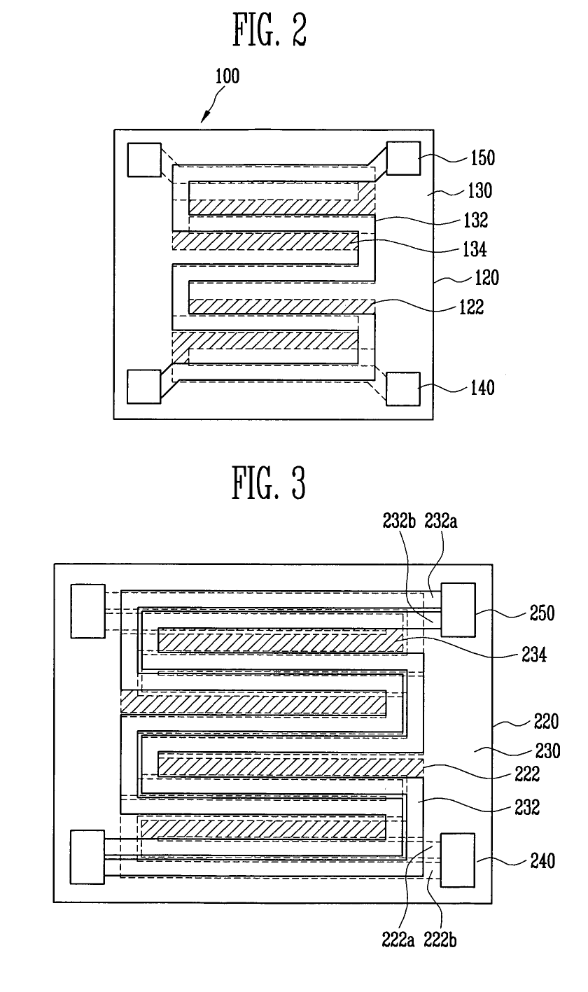

FIG. 2 is a plan view of a bipolar plate 100 according to one embodiment of the present invention. In FIG. 2, the fuel flow passage 122 is formed (or projected) on a cathode side surface of the bipolar plate 100. In FIG. 2, the fuel flow passage 122 and an oxidant flow passage 132 are shown with a slight displacement to distinguish between the flow passages 122 and 132 of the bipolar plate 100. The fuel flow passage 122 corresponds to an anode flow passage, and the oxidant flow passage 132 corresponds to a cathode flow passage.

Referring to FIG. 2, the bipolar plate 100 includes a first plate 120 formed with the fuel flow passage 122 and a second plate 130 formed with the oxidant flow passage 132. The first and second plates 120 and 130 are adhered to form a single body. In FIG. 2, the first plate 120 is not clearly shown because it is placed behind the second plate 130. For convenience purposes, the fuel flow passage 122 of the first plate 120 is drawn with dotted lines.

The bipolar plate 100 of FIG. 2 is characterized in that the fuel flow passage 122 and the oxidant flow passage 132 are partially opposite to each other, and a land 134 defined by the oxidant flow passage 132 having a first meandering shape is partially opposite to the fuel flow passage 122 having a second meandering shape. In FIG. 2, an opposite region between the land 134 and the fuel flow passage 122 is hatched. The land 134 may be also referred to as a channel land, a rib, or a channel rib.

In one embodiment, the width of the land 134 of the second plate 130 corresponds to two times the width of a land of the first plate 120. The width of the land 134 is sized such that the land 134 is formed to be partially and periodically opposite to the fuel flow passage 122.

Both ends of the fuel flow passage 122 are connected to an anode manifold 140 used as a passage for supplying liquid fuel containing hydrogen, such as methanol, and for discharging un-reacted fuel and reaction product. Further, both ends of the oxidant flow passage 132 are connected to a cathode manifold 150 used as a passage for supplying an oxidant and for discharging un-reacted oxidant and reaction product.

The bipolar plate is, in one embodiment, made of a material (which may be predetermined) having enough of a non-porosity characteristic to separate the fuel and the oxidant (or air) from each other, having a high electric conductivity characteristic, and having enough of a thermal conductivity characteristic to control the temperature of the fuel cell. Further, the bipolar plate is, in one embodiment, made of a material (which may be predetermined) having enough of a strength characteristic to sustain a force for clamping the fuel cell units and enough of a corrosion resistance characteristic to resist hydrogen ions.

With this configuration, an oxygen-rich region and an oxygen depletion region are formed on the cathode of a fuel cell stack having the bipolar plate. The two regions function as two electrically connected but ionically isolated independent cells. In other words, the oxygen depletion region functions as an electrolytic cell, whereas the oxygen-rich region still functions as a galvanic cell (a normal DMFC operation) to provide a voltage between the two electrodes. As a result, a fuel cell stack for generating hydrogen gas on the fuel flow passage will be produced. The generated hydrogen gas is supplied as the fuel to the anode, thereby improving the output performance of the fuel cell stack.

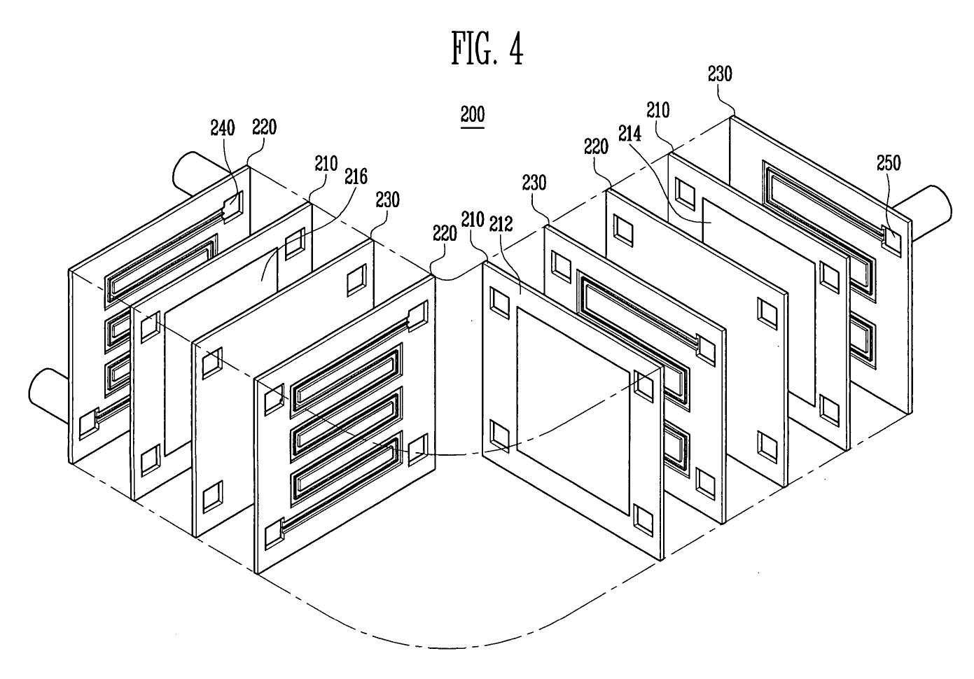

FIG. 3 is a plan view of a bipolar plate according to another embodiment of the present invention.

Referring to FIG. 3, the bipolar plate includes a first plate 220 formed with a fuel flow passage 222 having two channels 222a and 222b, and a second plate 230 formed with an oxidant flow passage 232 having two channels 232a and 232b. In FIG. 3, the first plate 220 is not clearly shown because it is placed behind the second plate 230. For convenience purposes, the fuel flow passage 222 of the first plate 220 is drawn with dotted lines.

The bipolar plate of FIG. 3 is characterized in that the fuel flow passage 222 having the plurality of channels 222a and 222b and the oxidant flow passage 232 having the plurality of channels 232a and 232b are partially opposite to each other, and a land 234 defined by the oxidant flow passage 232 having a first meandering shape is partially opposite to the fuel flow passage 222 having a second meandering shape. In FIG. 3, an opposite region between the land 234 and the fuel flow passage 222 is hatched.

In one embodiment, the width of the land 234 corresponds to the sum of the width of at least one of the channels 232a and 232b of the fuel flowing passage 222 and the doubled width of a rib between the channels 222a and 222b of the fuel flowing passage 222. The width of the land 234 is sized such that the land 234 is formed to be partially and periodically opposite to the fuel flow passage 222.

Both ends of the fuel flow passage 222 are connected to an anode manifold 240 used as a passage for supplying liquid fuel, such as methanol, and for discharging un-reacted fuel and reaction product. Further, both ends of the oxidant flow passage 232 are connected to a cathode manifold 250 used as a passage for supplying an oxidant and for discharging un-reacted oxidant and reaction product.

Various examples in manufacturing a bipolar plate according to the present invention will be described below.

In a first example of the present invention, a bipolar plate (e.g., 220, 230) includes an amorphous zirconium alloy composition.

The amorphous zirconium alloy composition is an alloy of zirconium ranging from 40 to 45 wt % and one or more elements selected from a group consisting of titanium (Ti), nickel (Ni), copper (Cu), yttrium (Y), beryllium (Be), niobium (Nb), chrome (Cr), vanadium (V) and cobalt (Co).

Further, the zirconium alloy composition has a specific gravity ranging from 0.2 to 0.99 and is an amorphous structure. The zirconium composition may be made by using a composition referred to as a “liquid metal”. Alternatively, the zirconium alloy composition may be made directly.

The amorphous zirconium alloy composition has a high conductivity characteristic (similar to metal) and a strength characteristic that is three times higher than steel and ten times higher than magnesium. Further, the amorphous zirconium alloy composition has a high corrosion resistance characteristic, such that the bipolar plate is not easily corroded while the fuel cell is in operation, thereby increasing the lifetime of the fuel cell.

In particular, unlike a conventional metal composition, which returns to its original crystal structure when it is cooled, the amorphous zirconium alloy composition maintains an amorphous structure in its solid state. Therefore, the amorphous zirconium alloy composition has a high strength and resilience characteristic because it has no vulnerable part or no knot point.

Further, the amorphous zirconium alloy composition has a high fluidity characteristic at a low temperature of about 600° C. such that the bipolar plate can be formed into a desired shape (or a predetermined shape) by using a die casting method. In addition, the bipolar plate using the amorphous zirconium alloy composition can be easy to manufacture, and the fuel cell with the bipolar plate can be lightweight and thin.

In a second example of the present invention, a bipolar plate (e.g., 220, 230) has a surface roughness ranging from 0.1 μm to 50 μm and includes at least one material selected from a group consisting of metal, metal coated with a coating layer, graphite, and carbon. In one embodiment, the metal includes Al, Cu, Ti, stainless steel, etc. In one embodiment, the coating layer includes Au, Pt, gold nitride, gold boride, gold oxide, platinum conductive nitride, platinum boride, platinum oxide, polymer (such as poly pyrrole, poly aniline), etc.

The surface roughness (i.e. Ra) can be obtained by an arithmetical mean of peaks according to the heights of the surface of the bipolar plate. In one embodiment, the surface roughness Ra ranges from 0.1 μm to 50 μm. In a more specific embodiment, the surface roughness Ra ranges from 1 μm to 10 μm. It is very difficult and expensive to lower the surface roughness below 0.1 μm. Further, when the surface roughness is higher than 50 μm, the number of point contacts increases and contact resistance increases, thereby requiring a large coupling pressure. An excessive (or excessively large) coupling pressure destroys a porous structure of a membrane electrode assembly, deteriorates the performance of the membrane electrode assembly, and requires a need to increase the strength of the bipolar plate to sustain the excessive coupling pressure.

In a third example of the present invention, a bipolar plate (e.g., 220, 230) is made of a metal base material, and in one embodiment, has a hydrophobic coating layer in its oxidant flow passage.

In one embodiment, the metal base material includes stainless steel, aluminum, titanium, copper, etc. The hydrophobic coating layer is formed by coating the metal base material with a fluoric resin composition. The fluoric resin includes poly-tetrafluoroethylene, poly-vinylidene-fluoride, and/or poly-tetrafluoroethylene-co-hexafluoropropylene. As a solvent for the fluoric resin composition, N-methylpyrrolidone, dimethylacetamide, or a both hydrophobic and hydrophilic surfactant can be used by dispersing the solvent into water to form an emulsion (or mixture). Here, any coating process can be used as long as only the channel is selectively coated with the fluoric resin composition.

In one embodiment, the hydrophobic coating layer has a thickness ranging from 1 μm to 100 μm. When the hydrophobic coating layer is thinner than 1 μm, the coating layer may peel off by thermal expansion and thermal retraction due to temperature change during the operations (and stopping of operations) of the fuel cell. On the other hand, when the hydrophobic coating layer is thicker than 100 μm, the thickness of the bipolar plate increases.

In the bipolar plate with this configuration, the hydrophobic coating layer is formed in only the channel and not formed in a part contacting the membrane electrode assembly, so that water generated when the fuel cell operates is effectively discharged, and thus the physical properties of the fuel cell are not deteriorated.

In a fourth example of the present invention, a bipolar plate (e.g., 220, 230) is made of a metal base material, and is provided with a carbon-coating layer including quasi-crystal carbon and graphitic catalyst.

In one embodiment, the metal base material includes stainless steel (e.g., 303, 310, 316, 316L, 904L), aluminum alloy, titanium, titanium alloy, etc. Further, the graphitic catalyst can include a material selected from a group consisting of Ni, Fe, Cr, Co, Cu, Ca, Mg, Si, B, Ti, Ga, Ge and Al. In one embodiment, the content of the graphitic catalyst ranges from 10 ppm to 1000 ppm with respect to the total weight of the carbon coating layer.

Further, in one embodiment, the thickness of the carbon coating layer ranges from 1,000 Å to 100 μm. In a more specific embodiment, the thickness of the carbon coating layer ranges from 5,000 Å to 50 μm. When the carbon coating layer is thinner than 1,000 Å, a fine hole such as a pin hole may be formed in the carbon coating layer, so that the carbon coating layer cannot protect the metal base material. On the other hand, when the carbon coating layer is thicker than 100 μm, the metal coating layer may crack due to a difference in the thermal expansion between the carbon coating layer and the metal base material

The carbon coating layer is constructed by forming a channel in the metal base material, and coating an amorphous carbon precursor and a composition having the graphitic catalyst on the metal base material formed with the channel. The amorphous carbon precursor includes phenol resin, naphthalene resin, polyvinyl alcohol resin, urethane resin, polyimide resin, furan resin, cellulose resin, epoxy resin, polystyrene resin, coal pitch, petroleum pitch, tar and/or heavy oil having small molecular weight. In one embodiment, the amorphous carbon precursor and the graphitic catalyst are mixed in a ratio ranging from 99.99 to 7.5 through 0.01 to 25. Then, the obtained product is heat-treated. The heat-treatment process is performed under an inert gas atmosphere or an air atmosphere at a temperature ranging from about 2,000° C. to 3,000° C. The heat-treatment process transforms the amorphous carbon precursor into a quasi-crystal carbon structure that is between amorphism and crystalloid, so that the final coating layer includes quasi-crystal carbon and graphitic catalyst.

In a fifth embodiment of the present invention, the bipolar plate 220, 230 is made of a metal plate including a metal element M. In one embodiment, the metal plate is provided with a coating layer containing at least one conductive oxide (e.g., LaMₓO₃ (x=0 to 1)).

Here, LaMₓO₃ is an electron conductive oxide that has a high corrosion resistance characteristic. Therefore, the bipolar plate (e.g., 220, 230) manufactured by the foregoing method has the high corrosion resistance characteristic to an internal corrosive environment of the fuel cell.

In a sixth example of the present invention, a bipolar plate (e.g., 220, 230) includes stainless steel containing tungsten and/or molybdenum.

Tungsten has good acid resistance as compared with other metal, so that a fuel cell separate plate containing tungsten also has good acid resistance. In particular, stainless steel alloy containing tungsten has a high corrosion resistance characteristic to sustain an acid environment such as a hydrogen atmosphere or an atmosphere including hydrogen (i.e., the corrosion resistance of stainless steel alloy containing tungsten is higher than the corrosion resistance of stainless steel alloy containing no tungsten).

In one embodiment, the bipolar plate (e.g., 220, 230) is made of stainless steel containing chrome (Cr), nickel (Ni) and iron (Fe). Further, in one embodiment, the bipolar plate (e.g., 220, 230) contains tungsten (W) for enhancing the corrosion resistance characteristic. Also, in one embodiment, the tungsten content of the first plate (e.g., 220) of the bipolar plate (e.g., 220, 230) is more than that of the second plate (e.g., 230). Here, in one embodiment, the total contents of tungsten range from 0.01 wt % to 15 wt %.

In one embodiment, the tungsten content of the first plate (e.g., 220) ranges from 0.01 wt % to 15 wt % (including 15 wt %) when the stainless steel containing tungsten, chrome, nickel, and iron is regarded as 100 wt %. Also, in one embodiment, the tungsten content of the second plate (e.g., 230) ranges from 0.01 wt % to 6 wt % (including 0.01 wt % and 6 wt %). In a more specific embodiment, the tungsten contents of the first and second plates (e.g., 220 and 230) range from 1 wt % to9 wt % and from 0.5 wt % to 4.5 wt %, respectively.

When the tungsten content of the bipolar plate (e.g., 220, 230) is lower than 0.01 wt %, the corrosion resistance to acid is only slightly improved. Further, when the tungsten content of the bipolar plate (e.g., 220, 230) is higher than 15 wt %, the corrosion resistance to the acid is not improved to such a degree that would economically justify a further increase to the tungsten content. In particular, when the tungsten content of the second plate (e.g., 230) having a surface facing the cathode electrode is higher than 6 wt %, the corrosion resistance to the acid is not improved to a degree that would economically justify a further increase to the tungsten content.

In one embodiment, the stainless steel contains chrome (Cr) ranging from 13 wt % to 30 wt %, nickel (Ni) ranging from 5 wt % to 30 wt %, and iron (Fe) ranging from 40 wt % to 80 wt %. Here, if the chrome content is lower than 13 wt %, a passivation film for the stainless steel is not stably formed such that there is not enough corrosion resistance. On the other hand, if chrome content is higher than 30 wt %, it is difficult to treat (or process) the stainless steel. In addition, nickel is used as an austenite stabilizer, so that the weight percent of austenite in the stainless steel increases as the nickel content becomes higher. If nickel is lower than 5 wt %, the stainless steel is not made into austenite steel but instead is made into ferrite stainless steel. The more nickel is used, the more the local corrosion resistance increases. However, nickel is expensive, so that it may not be economically worthwhile when the nickel content is higher than 30 wt %. In addition, iron content is determined in order to form the 100 wt %.

In addition to tungsten, the second plate (e.g., 230) according to one embodiment includes molybdenum ranging from 0.2 wt % to 5 wt % when the stainless steel is regarded as 100 wt %. In a more specific embodiment, the molybdenum content ranges from 1 wt % to 4 wt %. The molybdenum is added to the stainless steel containing tungsten to improve the stainless steel's corrosion resistance characteristic under the oxygen atmosphere. When the molybdenum content is lower than 0.2 wt %, there is not enough of an improvement to the corrosion resistance characteristic of the stainless. On the other hand, when the molybdenum content is higher than 5 wt %, a second phase (sigma phase and/or a chi phase) deteriorating the corrosion resistance and the mechanical properties of the stainless steel may result.

In the fuel cell employing the bipolar plate manufactured by the sixth example of the present invention, a relationship between a cathode and an anode is as follows.

First, the anode has a low pH level because of the hydrogen flow and because an acid material is produced from the membrane electrode assembly. The stainless steel further containing tungsten effectively resists corrosion due to the hydrogen atmosphere, so that the anode according to one embodiment of the present invention is made with the stainless steel containing tungsten.

The cathode is an oxygen reduction electrode and has the oxygen atmosphere. Here, tungsten also contributes to the corrosion resistance in the oxygen atmosphere, but the contribution to the corrosion resistance is slight when the tungsten content is higher than 6 wt %.

In particular, pitting corrosion is likely to occur in the cathode. The pitting corrosion is a localized form of corrosion by which cavities or holes are produced in the material. The pitting corrosion causes a hole having a hemispherical shape or a cup shape to be formed, and the hole may be further corroded when it is covered with corrosion products. Pitting corrosion should be prevented not only because it can corrode away the cathode but also because it contributes to stress fatigue and stress corrosion cracking.

Molybdenum improves the resistance to pitting corrosion. Therefore, in one embodiment of the present invention, the cathode is made with the stainless steel alloy containing molybdenum.

In addition, the bipolar plate should have a high electric conductivity (electric conductivity>10 S/cm); resist corrosion due to acid electrolyte, hydrogen, oxygen, heat, moisture, etc. (corroding speed<16 μA/cm²); have a high thermal conductivity (thermal conductivity>20 W/mk); and be airtight (airtightness<10₋₇ mbar l/s cm²).

As described above, the bipolar plate (e.g., 220, 230) according to an embodiment of the present invention has an electric conductivity of 10 S/cm and more. When the electric conductivity of the bipolar plate is lower than 10 S/cm, the efficiency of the fuel cell is lowered. Further, in one embodiment, the bipolar plate (e.g., 220, 230) has a current density that is less than 16 μA/cm² due to the corrosion. When the current density due to the corroded bipolar plate is higher than 16 μA/cm², there is too much, thereby shortening the lifespan of the fuel cell.

Referring to FIG. 4, a fuel cell stack 200 includes a plurality of electrolyte membranes 212, a plurality of anode electrodes 214, a plurality of cathode electrodes 216, a plurality of bipolar plates 220, 230, and a plurality of gaskets. Each electrolyte membrane 212 is located between a pair of electrodes 214 and 216 to form a membrane electrode assembly (MEA) 210. Each bipolar plate 220, 230 includes a first plate 220 facing an anode electrode 214 and a second plate 230 facing a cathode electrode 216. Each gasket is interposed between each membrane electrode assembly 210 and each bipolar plate 220, 230. The membrane electrode assembly 210, the gasket 260, and the first and second plates 220 and 230 are stacked successively to form the fuel cell stack 200.

The membrane electrode assembly 210 induces oxidation and reduction reactions of the fuel and the oxidant received from the outside, thereby generating electricity. In one embodiment, the anode electrode 214 of the membrane electrode assembly 210 includes a catalyst layer to separate the fuel received through the first plate 220 into electrons and hydrogen ions by an oxidation reaction, and a diffusing layer to smoothly transfer the electron and the hydrogen ions. Further, the cathode electrode 216 includes a catalyst layer to separate the oxidant, e.g., oxygen in air, received through the second plate 230 into electrons and oxygen ions by a reduction reaction, and a diffusing layer to smoothly transfer air and discharge produced water. Also, the electrolyte membrane 212 is a solid polymer electrolyte having a thickness ranging from 10 μm to 200 μm. The electrolyte membrane 212 has an ion exchange function for transferring the hydrogen ions produced in the catalyst layer of the anode electrode 214 toward the catalyst layer of the cathode electrode 216.

The first and second plates 220 and 230 are used as a conductor to connect the anode electrode 214 and the cathode electrode 216 of the membrane electrode assembly 210 in series, and as a passage through which fuel and air needed for oxidation and reduction of the membrane electrode assembly 210 are supplied to the anode electrode 214 and the cathode electrode 216, respectively.

In more detail and referring also to FIG. 3, in the first and second plates 220 and 230, at least a part of the land 234 defined by the oxidant flow passage 232 with the first meandering shape is formed to be periodically opposite to the fuel flow passage 222 with the second meandering shape, so that an oxygen-rich region and an oxygen depletion region are formed on a cathode of the fuel cell stack 200, thereby generating hydrogen gas in the fuel flow passage. The generated gas is used as secondary fuel and that can be rapidly reacted in the anode electrode 214. Therefore, the fuel cell stack 200 operates both as a direct methanol fuel cell (DMFC) using liquid fuel and as a polymer electrolyte membrane fuel cell (PEMFC) using hydrogen gas, so that the fuel cell stack 200 has an output performance that is higher than that of the conventional DMFC with the same size/weight.

The electrochemical reaction of the fuel cell stack 200 shown in FIG. 4 is as follows. Reaction 1 represents the electrolytic reactions in the oxygen depletion region, and reaction 2 represents the galvanic cell reactions in the oxygen-rich region.
Anode: CH₃OH+H₂O CO₂ (g)+6H⁺+6e⁻
Cathode: 2H⁺+2e⁻→H₂ (g) [Reaction 1]
Cathode: CH₃OH +H₂O→CO₂ (g)+6H⁺+6e⁻
Anode: 3/2O₂+6H⁺+6e⁻→3H₂O [Reaction 2]

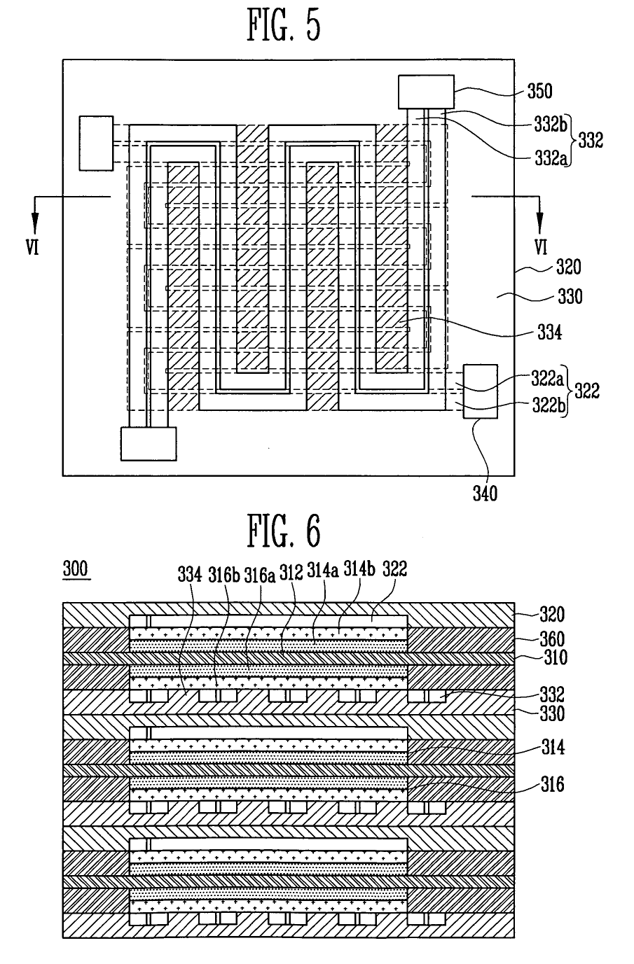

FIG. 5 is a plan view of a bipolar plate according to yet another embodiment of the present invention.

Referring to FIG. 5, the bipolar plate includes a first plate 320 formed with a fuel flow passage 322 having a plurality of channels 322a, 322b; and a second plate 330 formed with an oxidant flow passage 332 having a plurality of channels 332a, 332b. In FIG. 3, the first plate 320 is not clearly shown because it is placed behind the second plate 330. For convenience purposes, the fuel flow passage 322 of the first plate 320 is drawn with dotted lines.

The bipolar plate of FIG. 5 is characterized in that the fuel flow passage 322 having the plurality of channels 322a and 322b, and the oxidant flow passage 332 having the plurality of channel 332a and 332b are intersected with (or cross) each other, and a land 334 defined by the oxidant flow passage 332 is formed to be partially and periodically opposite to the fuel flow passage 322. In FIG. 5, an opposite region between the land 334 and the fuel flow passage 322 is hatched.

In one embodiment, the width of the land 334 defined by (or surrounded with) the oxidant flow passage 332 of the second plate 130 is wider than the width of at least one of the channels 322a and 322b of the fuel flowing passage 322. The width of the land 334 is sized such that an oxygen depletion region and an oxygen-rich region are properly formed on the cathode of a fuel cell stack using the bipolar plate. That is, if the width of the land 334 is smaller than at least one of the channels 322a and 322b of the fuel flow passage 322, the oxygen depletion region formed may not be enough to significantly improve the output performance.

Both ends of the fuel flow passage 322 are connected to an anode manifold 340 used as a passage for supplying liquid fuel, such as methanol, and for discharging un-reacted fuel and reaction product. Further, both ends of the oxidant flow passage 332 are connected to a cathode manifold 350 used as a passage for supplying an oxidant and for discharging un-reacted oxidant and reaction product.

With this configuration, the oxygen-rich region and the oxygen depletion region are formed on the cathode. In other words, on the cathode, the permeated methanol reacts with oxygen, and the reactions will cause oxygen in the region under the channel ribs between the lands 334 to be exhausted first, forming an oxygen depletion region. By contrast, in the region under the channel openings not opposite the lands 134, oxygen still remains at a relatively rich level to thus form a localized oxygen-rich region. The two regions function as two electrically connected but ionically isolated independent cells. The oxygen depletion region functions as an electrolytic cell, whereas the oxygen-rich region still functions as a galvanic cell. As a result, a fuel cell stack for generating hydrogen gas on the fuel flow passage will be produced. The generated hydrogen gas is supplied as the fuel to the anode, thereby improving the output performance of the fuel cell stack.

In this embodiment, the first and second plates 320 and 330 are manufactured and then assembled into the bipolar plate 320, 330, thereby facilitating the manufacturing process of the bipolar plate 320, 330. Alternatively, the anode flow passage and the cathode flow passage may be formed in opposite sides of a single plate.

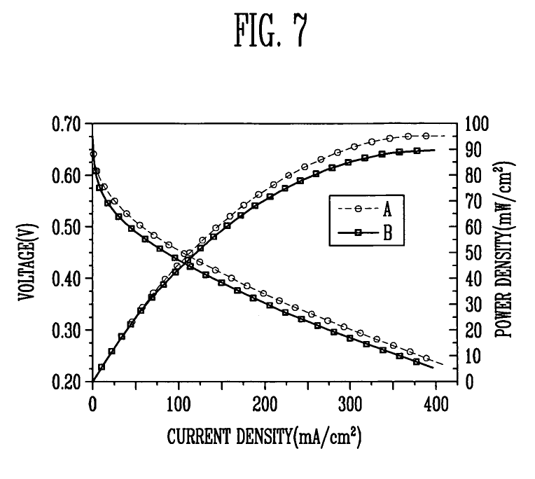

FIG. 6 is a sectional view of a fuel cell stack 600 using the bipolar plate 320, 330 of FIG. 5.

Referring to FIG. 6, the fuel cell stack 300 includes a plurality of electrolyte membranes 312, a plurality of anode electrodes 314, a plurality of cathode electrodes 316, a plurality of bipolar plates 320, 330, and a plurality of gaskets 360. Each electrolyte membrane 312 is located between a pair of electrodes 314 and 316 to form a membrane electrode assembly (MEA) 310. Each bipolar plate 320, 330 includes a first plate 320 facing an anode electrode 314 and a second plate 330 facing a cathode electrode 316. Each gasket 360 is interposed between each membrane electrode assembly 310 and each bipolar plate 320, 330. The membrane electrode assembly 310, the gasket 360, and the first and second plates 320 and 330 are stacked successively to form the fuel cell stack 300.

The membrane electrode assembly 310 induces oxidation and reduction reactions of the fuel and the oxidant received from the outside, thereby generating electricity. In one embodiment, the anode electrode 314 of the membrane electrode assembly 310 includes a catalyst layer 314a to transform the fuel received through the first plate 320 and the self-generated hydrogen gas into electrons and hydrogen ions by an oxidation reaction, and a diffusing layer 314b to smoothly transfer the electron and the hydrogen ions. Further, the cathode electrode 316 includes a catalyst layer 316a to transform the oxidant, e.g., oxygen in air received through the second plate 330 into electrons and oxygen ions by a reduction reaction, and a diffusing layer 316b to smoothly transfer air and discharge produced water. Also, the electrolyte membrane 312 is a solid polymer electrolyte having a thickness ranging from 50 μm to 200 μm. The electrolyte membrane 312 has an ion exchange function for transferring the hydrogen ions produced in the catalyst layer 314a of the anode electrode 314 toward the catalyst layer 316a of the cathode electrode 316.

The first and second plates 320 and 330 are used as a conductor to connect the anode electrode 314 and the cathode electrode 316 of the membrane electrode assembly 310 in series, and as a passage through which fuel and air needed for oxidation and reduction of the membrane electrode assembly 310 are supplied to the anode electrode 314 and the cathode electrode 316, respectively.

In more detail, because the fuel flow passage 322 of the first plate 320 and the oxidant flow passage 332 of the second plate 330 are intersecting with (or crossing) each other, and the land 334 placed between the oxidant flow passages 332 is partially and periodically opposite to the fuel flow passage 322, some liquid fuel supplied from the anode electrode 314 to the cathode electrode 316 via the electrolyte membrane 312 is oxidized around the land 334 at the oxygen depletion state and is then separated into hydrogen ions and electrons. The produced hydrogen ion returns to the anode electrode 314 and gets the electrons from the anode electrode 314 to be thereby transformed into hydrogen gas. Then, the hydrogen gas passes through the anode flow passage 322 and is oxidized as highly reactive fuel in the anode electrode 314.

A method of manufacturing the fuel cell stack includes adhering one side of the gasket 360 to each side of the membrane electrode assembly 310 using an acrylate glue, and adhering the first plate 320 or the second plate 330 to the other side of the gasket 360, thereby manufacturing a unit cell.

In the manufacturing of the unit cell, the order of adhering the membrane electrode assembly 310 with the gasket 360, and adhering the gasket 360 with the first and second plates 320 and 330 can be varied in various suitable orders. For example, the first and second plates 320 and 330 may be adhered to the gasket 360 after adhering the membrane electrode assembly 310 with the gasket 360. Alternatively, after adhering two gaskets 360 with the first and second plates 320 and 330, they may be adhered to the opposite sides of the membrane electrode assembly 310. However, when the membrane electrode assembly 310 is adhered with the gasket 360, the gasket 260 is not overlapped with the anode electrode 314 and the cathode electrode 316 formed in the opposite sides of the membrane electrode assembly 310, so that one side of the gasket 360 is adhered by the glue to the opposite sides of the electrolyte membrane 312 exposed to the edge of the membrane electrode assembly 310.

With this configuration, some liquid fuel supplied from the anode electrode 314 to the cathode electrode 316 via the electrolyte membrane 312 is oxidized around the land 334 in the oxygen depletion state and separated into hydrogen ions and electrons. The produced hydrogen ion is transferred to the anode electrode 314 and is provided with the electrons from the anode electrode 314, thereby transforming into hydrogen gas. Then, the hydrogen gas passes through the anode flow passage 322 and is oxidized as highly reactive fuel in the anode electrode 314. Thus, the highly reactive hydrogen fuel improves the output performance of the fuel cell stack 300.

FIG. 7 is a graph showing the output performance of a fuel cell stack according to an embodiment of the present invention (e.g., the fuel cell stack of FIG. 4).

As shown in FIG. 7, the fuel cell stack, in which the fuel flow passage and the oxidant flow passage are partially opposite to each other as, e.g., shown in FIG. 3, is compared with the fuel cell stack, in which the fuel flow passage and the oxidant flow passage are fully opposite to each other, with respect to voltage and current density.

That is, the output density A of the fuel cell stack according to the embodiment of the present invention is higher than the output density B of the fuel cell stack according to the comparative example.

As described above, the present invention provides a bipolar plate and a fuel cell stack using the same, which can improve an output performance of a fuel cell system without increasing the volume of the fuel cell stack. Further, the fuel cell stack can be decreased in size without decreasing a performance of a fuel cell system.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A bipolar plate used in a fuel cell stack, the bipolar plate comprising:
a first plate having a fuel flow passage; and
a second plate having an oxidant flow passage and a land, the land being on the second plate and formed to be partially opposite to the fuel flow passage.

2. The bipolar plate according to claim 1, wherein the oxidant flow passage has a meandering shape, wherein the land on the second plate has a first width and a land on the first plate formed to be substantially opposite to the oxidant flow passage has a second width, and wherein the first width is two times larger than the second width.

3. The bipolar plate according to claim 1, wherein at least one of the fuel flow passage or the oxidant flow passage comprises a plurality of channels to guide the fuel or the oxidant.

4. The bipolar plate according to claim 3, wherein the oxidant flow passage has a meandering shape, wherein the land on the second plate has a first width, wherein one of the channels has a second width, and a rib between the channels has a third width, and wherein the first width is equal to the second width plus twice the third width.

5. The bipolar plate according to claim 3, wherein the fuel flow passage has a first meandering shape and the oxidant flow passage has a second meandering shape, and wherein the fuel flow passage and the oxidant flow passage are substantially crossed with each other.

6. The bipolar plate according to claim 5, wherein a width of the land defined by the oxidant flow passage is larger than a width of one of the channels of the fuel flow passage.

7. The bipolar plate according to claim 1, wherein the first plate and the second plate are adhered to expose the fuel flow passage and the oxidant flow passage to opposite sides thereof.

8. The bipolar plate according to claim 1, wherein the first and second plates include an amorphous zirconium alloy composition.

9. The bipolar plate according to claim 1, wherein the first and second plates have a surface roughness ranging from about 0.1 to 50 μm, and include at least one material selected from a group consisting of metal, metal coated with a coating layer, graphite, and carbon composite materials.

10. The bipolar plate according to claim 1, wherein the first and second plates include metal base materials, and further include a hydrophobic coating layer formed in the oxidant flow passage.

11. The bipolar plate according to claim 1, wherein the first and second plates include metal base materials, and further include a carbon coating layer containing quasi-crystal carbon and graphitic catalyst.

12. The bipolar plate according to claim 1, wherein the first and second plates include a metal plate containing a metal element M, wherein the first and second plates further include a coating layer formed on the metal plate and containing at least one conductive oxide represented by LaMₓO₃, and wherein x ranges from 0 to 1.

13. The bipolar plate according to claim 1, wherein the first and second plates include stainless steel containing tungsten and/or molybdenum.

14. The bipolar plate according to claim 1, wherein the fuel flow passage and the oxidant flow passage are not fully opposite to each other.

15. A fuel cell stack comprising:
a polymer electrolyte membrane;
an anode electrode and a cathode electrode respectively placed on opposite sides of the polymer electrolyte membrane;
a first plate placed on the anode electrode, and having a fuel flow passage; and
a second plate placed on the cathode electrode, and having an oxidant flow passage and a land, the land being on the second plate and formed to be partially opposite to the fuel flow passage.

16. The fuel cell stack according to claim 15, wherein the oxidant flow passage has a meandering shape, wherein the land on the second plate has a first width and a land on the first plate formed to be substantially opposite to the oxidant flow passage has a second width, and wherein the first width is two times larger than the second width.

17. The fuel cell stack according to claim 15, wherein at least one of the fuel flow passage or the oxidant flow passage comprises a plurality of channels to guide the fuel or the oxidant.

18. The fuel cell stack according to claim 17, wherein the oxidant flow passage has a meandering shape, wherein the land on the second plate has a first width, wherein one of the channels has a second width, and a rib between the channels has a. third width, and wherein the first width is equal to the second width plus twice the third width.

19. The fuel cell stack according to claim 17, wherein the fuel flow passage has a first meandering shape and the oxidant flow passage has a second meandering shape, and wherein the fuel flow passage and the oxidant flow passage are substantially crossed with each other.

20. The fuel cell stack according to claim 19, wherein a width of the land defined by the oxidant flow passage is larger than a width of one of the channels of the fuel flow passage.

21. The fuel cell stack according to claim 15, wherein the first plate and the second plate are adhered to expose the fuel flow passage and the oxidant flow passage to opposite sides thereof.
